(19) United States
(12) Patent Application Publication
(10) Pub. No.: US 2010/0074258 A1
(43) Pub. Date: Mar. 25, 2010

(54) METHOD AND SYSTEM FOR MANAGING ADDRESSES IN A NETWORK

(75) Inventor: Subba Reddy KOTA, Bangalore (IN)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/561,826

(22) Filed: Sep. 17, 2009

(30) Foreign Application Priority Data
Sep. 17, 2008 (IN) 2256/CHE/2008

(51) Int. Cl. H04L 12/56; H04L 12/28

(52) U.S. Cl. 370/392; 370/400

(57) ABSTRACT

Disclosed is a method for managing addresses in a network. The network includes a plurality of nodes. The method includes receiving at a first node, a node capability index value of a second node, from the second node. Further, the method includes determining at the first node, a set of addresses to be assigned to the second node based on the node capability index value of the second node. Thereafter, the method includes assigning the set of addresses to the second node by the first node. A system for managing the addresses in the network is also disclosed.

### PRIORITY

This application claims priority under 35 U.S.C. §119(e) to an application filed in the Indian Patent Office on Sep. 17, 2008 and assigned Serial No. 2256/CHE/2008, the contents of which are incorporated herein by reference.

### BACKGROUND OF THE INVENTION

1. Field of the Invention

The present invention generally relates to networks, and more particularly to address assignments in the networks.

2. Description of the Related Art

In general, a typical network includes a number of geographically distributed nodes, which are connected to one another using one or more logical wireless links, such as radio frequency communication channels, or by using wired links. These nodes may be fixed or mobile in the network, and may communicate with one another over the wireless links or the wired links. Such links between the nodes may change dynamically in an arbitrary manner, when certain nodes move within the network, when a new node joins the network, or when certain nodes leave the network.

As the nodes in the network need to communicate with one another, each node in the network is required to have a unique address. Few nodes of the network that are typically parent nodes are provided with a certain number of unassigned addresses. These parent nodes use these unassigned addresses for assigning addresses to their child nodes, or any incoming nodes that join the network by connecting to these parent nodes.

Existing methods, such as the ZigBee Specification (ZigBee Documentation 053474r13, Dec. 1, 2006) proposes a distributed address assignment method. This method provides each parent node of the network with a finite sub-block of addresses. At a given depth of the network, all potential parent nodes get the same number of unassigned addresses to assign to their child nodes.

Further, these methods distribute the sub-block of addresses equally among the possible nodes irrespective of the node's capabilities, such as energy of a node. Because of this, there is an equal chance for each node to serve the same number of child nodes irrespective of the node's capabilities. If a node with less energy happens to be serving a greater number of child nodes, the node may exhaust its energy. More specifically, the node may not be able to properly serve the child nodes, since the capability of the node is less than that required to server the child nodes. As the node continues serving beyond the node's capabilities, this may affect a network life time. Therefore, these methods do not provide efficient address assignment in the networks, especially in sensor networks, where the energy of a node is an important resource.

### SUMMARY OF THE INVENTION

In view of the foregoing disadvantages inherent in the prior art, the general purpose of the present invention is to provide a method and system that are configured to include all advantages of the prior art, and to overcome the drawbacks inherent therein.

It is therefore an object of the present invention to provide a method and system for employing an efficient address assignment mechanism in a network. Such an address assignment mechanism should take into account the capabilities of a node in the network.

To achieve at least the above objects, in one aspect, the present invention provides a method for managing addresses in a network. The network includes a plurality of nodes. The method includes receiving at a first node, a node capability index value of a second node, from the second node. The method further includes determining at the first node, a set of addresses to be assigned to the second node based on the node capability index value of the second node. Thereafter, the method includes assigning the set of addresses to the second node by the first node.

In another aspect, the present invention provides a system for managing addresses in a network including a plurality of nodes. The system includes a receiving module and an address assignment module. The receiving module is disposed in a first node and is configured to receive a node capability index value of a second node, from the second node. The address management module is also disposed in the first node and is in communication with the receiving module. The address assignment module is configured to assign a set of addresses to the second node based on the node capability index value of the second node.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

The features and advantages of the present invention will become more apparent from the following detailed description in conjunction with the accompanying drawings, in which:

FIG. 1 is a block diagram illustrating an exemplary network, where various embodiments of the present invention may be utilized;

FIG. 2 is a flow diagram of a method for managing addresses in a network, according to one embodiment of the present invention;

FIG. 3 is a flow diagram of a method for managing addresses in the network, according to another embodiment of the present invention;

FIG. 4 is a block diagram of a system for managing addresses in a network, according to one embodiment of the present invention; and

FIG. 5 is a block diagram of a system for managing addresses in the network, according to another embodiment of the present invention.

### DETAILED DESCRIPTION OF EXEMPLARY EMBODIMENTS

The method and system have been represented where appropriate by conventional symbols in the drawings, showing only those specific details that are pertinent to the understanding of the embodiments of the present invention so as not to obscure the disclosure with details that will be readily apparent to those of ordinary skill in the art having the benefit of the description herein.

Before describing in detail embodiments that are in accordance with the present invention, it is observed that the embodiments reside primarily in combinations of method steps and system components related to managing addresses in a network.

Relational terms such as first and second, and the like, may be used solely to distinguish one module or action from another module or action without necessarily requiring or implying any actual relationship or order between such modules or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that the embodiments of the invention described herein may comprise one or more conventional processors and unique stored program instructions that control the one or more processors to implement, in conjunction with certain non-processor circuits, some, most, or all functions of assigning addresses to nodes in a network. The non-processor circuits may include, but are not limited to, a radio receiver, a radio transmitter, signal drivers, clock circuits, power source circuits, and user input devices. Alternatively, some or all functions of assigning addresses to the nodes in the network could be implemented by a state machine that does not include stored program instructions, or in one or more Application Specific Integrated Circuits (ASICs), in which each function or some combinations of certain the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and Integrated Circuits (ICs) with minimal experimentation.

Any embodiment described herein is not necessarily to be construed as preferred or advantageous over other embodiments. All of the embodiments described in this detailed description are illustrative, and are provided to enable persons skilled in the art to make or use the invention and not to limit the scope of the invention, which is defined by the claims.

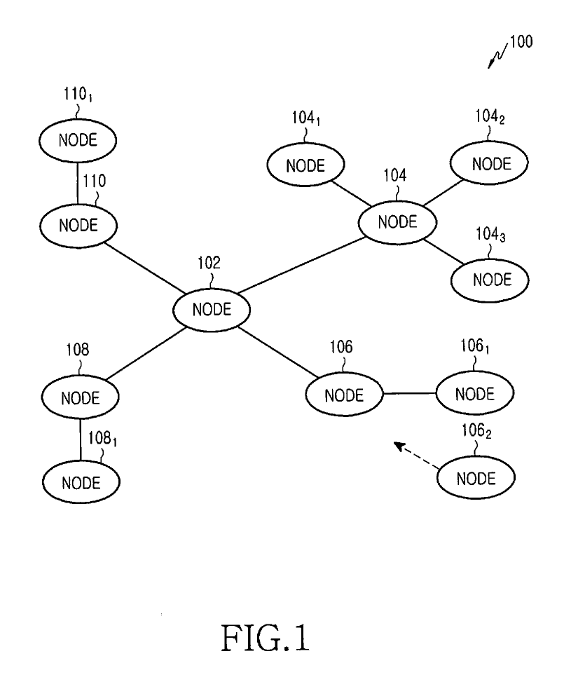

Referring now to FIG. 1, a block diagram of an exemplary network 100 is shown, where various embodiments of the present invention may be utilized. Examples of the network 100 may include, but are not limited to, a sensor network, a Personal Area Network (PAN), an energy constrained network, an Institute of Electrical and Electronics Engineers (IEEE) 802.15 network, or an IEEE 802.11 network (i.e. 802.11a, 802.11b, 802.11g, or 802.11s). It will be appreciated by those of ordinary skill in the art that the network 100 in accordance with the present invention may include any packetized communication network, where packets are forwarded across multiple wired or wireless connections. The network 100 may utilize protocols, such as a wireless Highway Addressable Remote Transducer (HRAT) Protocol, or other packet data protocols utilizing schemes, such as Orthogonal Frequency Division Multiple Access (OFDMA), Time Division Multiple Access (TDMA), General Packet Radio Service (GPRS), Enhanced GPRS (EGPRS), and the like.

As illustrated in FIG. 1, the network 100 includes a plurality of nodes, such as node 102, node 104, node 106, node 108 and node 110. Examples of the plurality of nodes may include, but are not limited to, communication devices, computers, routers, switches, or any signal processing or network devices. Each of the nodes in the network 100 has a unique address so that the each node may communicate with other nodes of the network 100. A node of the network 100 may be connected to other nodes as a parent node and/or a child node. For example, nodes 104, 106, 108 and 110 are connected to node 102. Node 102 may be termed as a parent node of nodes 104, 106, 108 and 110, and accordingly, nodes 104, 106, 108 and 110 may be considered as child nodes of node 102. A child node, such as node 104 is provided with its unique address by its parent node, i.e., node 102. Node 102 further provides a certain number of unassigned addresses to node 104 such that node 104 may assign addresses to nodes, such as node 104₁, node 104₂ and node 104₃, which are connected as child nodes to node 104.

The number of nodes as represented in FIG. 1 is for exemplary purposes only and it would be apparent to those ordinary skilled in the art that any number of nodes, and various connections among the nodes may be present in the network 100. Each of nodes 104, 106, 108 and 110 may further act as a parent node for their child nodes. For example, node 104 acts as a parent node for nodes 104₁, 104₂ and 104₃. Similarly, node 108 acts as a parent node for node 108₁ and node 110 acts as a parent node for node 110₁. Further, node 106₂ is also shown in FIG. 1, which tends to join the network 100. Node 106₂ may be hereinafter interchangeably referred to as an ‘incoming node’. It would be apparent to those skilled in the art that node 106₂ may join as a child node to any of the nodes, which exist in the network 100, for example, node 104, node 106 and node 104₁.

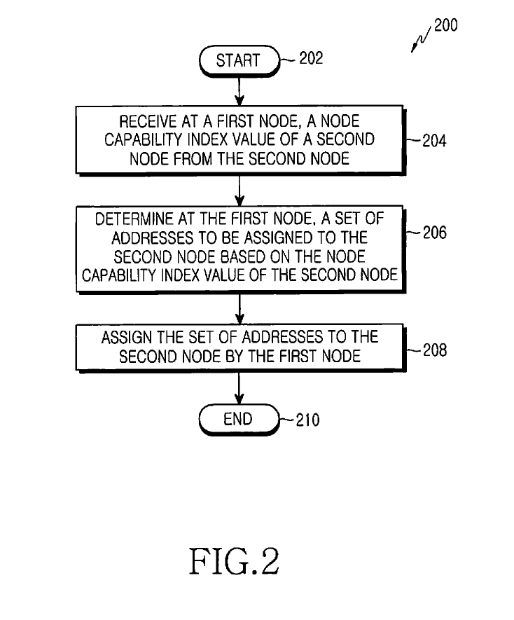

A node, which either tends to join the network 100, or is present in the network 100, requires managing of addresses corresponding to the node. Herein the addresses refer to the unique address of the node and a certain number of unassigned addresses available to the node for purposes such as assigning addresses to a child node of the node. The addresses need to be managed when a requirement of a number of unassigned addresses corresponding to the node changes with time for the node existing in the network 100. Further, the managing of the addresses corresponding to the node is also required, when the node joins the network 100 and the node requires the unique address and/or certain number of unassigned addresses to be assigned to the node. The method of managing the addresses among the nodes of the network 100 and the incoming node is described in conjunction with FIG. 2.

Referring now to FIG. 2, a flow diagram of a method 200 for managing addresses in a network, such as the network 100, is shown, according to one embodiment of the present invention. The method 200 explains the managing of the addresses between a parent node and a child node of the network 100, and it would be apparent to those skilled in the art that the method 200 may be utilized across the network 100 between any parent nodes and child nodes of the network 100. Herein the method 200 for managing the addresses between a parent node and a child node is explained by taking into consideration examples of node 106, node 106₁ and node 106₂, and it should not be considered limiting.

The method 200 for managing addresses starts at step 202. At step 204, a first node, such as, node 106, receives a Node Capability Index (NCI) value of a second node. Herein, the second node may be an existing node in the network 100, such as node 106₁, or an incoming node such as node 106₂. Consider a case, when the second node is node 106₂ and node 106₂ tends to join the network 100. In order to join the network 100, node 106₂ needs to be connected as a child node to node 106, which is the parent node. Accordingly, node 106₂ sends its NCI value to node 106.

The NCI value of the node 106₂ may depend upon a plurality of node capability parameters. These node capability parameters may include, but are not limited to, a power source, an energy level, a functional capability, a transceiver capability, a processing power and a storage capability. Herein, the power source for a node refers to type of the power source utilized for the functioning of the node, for example, a battery or a main power supply. Herein, the energy level corresponds to amount of energy storage in the node, in the case of the node being battery powered. The functional capability of the node may correspond to a type of the functionality of the node, for example, a Full Function Device (FFD) or a Reduced Function Device (RFD). The transceiver capability corresponds to the capability of the node, such as the bandwidth and the number of communication channels used by the node. The processing power refers to the performance of the node, for example, a processing speed of the node in performing arithmetical and logical operations, and in performing various control functions. The storage capability refers to the memory capacity of the node, i.e., the amount of data that may be stored at the node.

In one embodiment of the present invention, the NCI value of a node may be calculated based on the node capability parameters as represented by Equation (1):

NCI=k1*power source+k2*energy level+k3*functional capability+k4*transceiver capability+k5*processing power+k6*storage capability (1)

where k1, k2, k3, k4, k5 and k6 are constants. Values of k1 , k3, k4, k5 and k6 may be configured based on the type of applications for which the network 100 is used, such as computational intensive applications, data centric applications and communication intensive applications. Further, k2 is equal to zero if the power source is powered by the main.

After the NCI value of node 106₂ is received at node 106, node 106 determines a set of addresses to be assigned to node 106₂, at step 206. The set of addresses are determined based on the NCI value of node 106₂. Further, the set of addresses are assigned to node 106₂ by node 106. In one embodiment of the present invention, node 106 determines the set of addresses from the unassigned addresses available at node 106. More specifically, at step 206, the method 200 calculates a fraction of the unassigned addresses available at node 106 as the set of addresses.

In one embodiment of the present invention, the fraction of the unassigned addresses may be calculated based on the NCI value of node 106₂. More specifically, a fraction of the unassigned addresses may be calculated for each possible NCI value of a node based on Equation (2):

r1*c1+r2*c2+ . . . rn*cn=1 (2)

where r1, r2, . . . rn are fractions of unassigned addresses for each possible NCI, such as NCI₁, NCI₂, . . . NCIₙ. The values of r1, r2, . . . rn can be calculated based on Equation (2). c1, c2, . . . cn are constants. It will be apparent to those skilled in the art that in order to solve Equation (2), relationships between c1 , c2, . . . cn needs to be obtained. These relationships may be obtained based on the type of the application of the network 100.

After the set of addresses to be assigned to node 106₂ is determined at step 206, the method assigns the set of addresses to node 106₂, at step 208. Thereafter, node 106₂ may use the set of addresses, for example, node 106₂ may use one address as its unique address and may use remaining addresses for nodes that join as child nodes of node 106₂.

In one embodiment of the present invention, when node 106 does not have a sufficient number of unassigned addresses available for assigning the set of addresses to node 106₂, node 106 may assign each of the unassigned addresses available at node 106 to node 106₂. Though, the above explanation of managing the addresses is explained by taking way of an example using two nodes, node 106 and node 106₂, it will be apparent to those ordinary skilled in the art that the method may also be applied for managing addresses between node 106 and an existing child node of node 106, such as node 106₁.

Node 106₁ may have a certain number of unassigned addresses available to it as provided by node 106. The requirement of the number of unassigned addresses available at node 106₁ may change over time. Therefore, in one embodiment of the present invention, node 106₁ keeps negotiating with node 106 for addresses at periodic intervals. Alternatively, whenever there is a change in the NCI value of node 106₁, the method may be performed. A changed the NCI value of node 106₁ is received at node 106. Further, node 106 determines the set of addresses based on the changed NCI value of node 106₁. It will be apparent to a person skilled in the art that when the NCI value of node 106₁ increases, node 106₁ may be provided with a block of addresses by node 106. Thereafter, the block of addresses is further used by node 106₁. Similarly, when the NCI value of node 106₁ decreases, node 106₁ may return the block of addresses to node 106 based on the change in the NCI value.

Further, in the cases when a node, such as node 106₁ leaves the network 100, node 106₁ returns the unassigned addresses available at node 106₁ to its parent node, i. e., node 106. Further, it will be apparent to those skilled in the art that the method is performed between every parent-child connection of nodes in the network 100. For example, the method is performed between node 102 and nodes 104, 106, 108 and 110. Similarly, the method is also performed for managing the addresses between node 104 and nodes 104₁, 104₂ and 104₃.

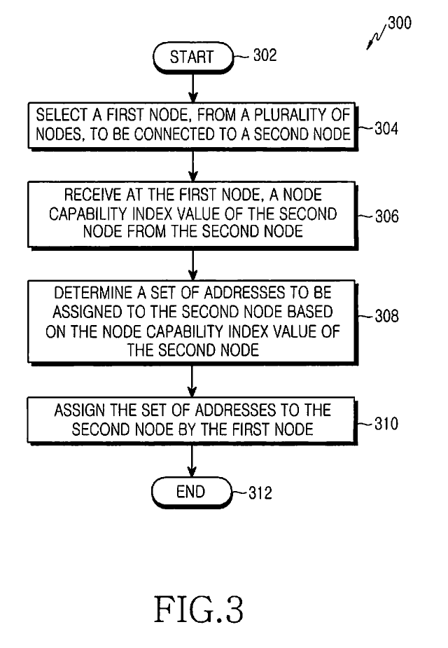

In another embodiment, the present invention also provisions choosing a parent node of network 100, to which an incoming node must be connected in order to join network 100. Such a method 300 for managing the addresses in network 100 is shown in FIG. 3.

Referring now to FIG. 3, the method 300 for managing the addresses is shown, according to another embodiment of the present invention. The present invention utilizes the method 300 when the second node is the incoming mode, such as node 106₂. When the second node 106₂ tends to join network 100, the present invention provides a selection of the first node that will act as the parent node for node 106₂. Hereinafter, the first node may be referred to as the ‘parent node’. The parent node may provide certain addresses to node 106₂ for the purposes of providing a unique address for node 106₂ and keeping a certain number of unassigned addresses available at node 106₂ so that node 106₂ may further act as a parent node for any child nodes that may connect to node 106₂.

The method 300 starts at step 302. The method 300 includes selecting the parent node from the nodes, for example, nodes 102, 104, 106, 108 and 110, for node 106₂, at step 304. The parent node is selected from nodes 102, 104, 106, 108 and 110 based on NCI values of nodes 102, 104, 106, 108 and 110. In one embodiment, the parent node is selected based on a comparison of NCI values of a set of nodes at node 106₂. Without departing from the scope of the present invention, the set of nodes may be those nodes, which are in proximity to a point of the network 100, where node 106₂ wishes to connect. Node 106₂ receives the NCI values of the set of nodes, for example, nodes 104 and 106. Node 106₂ may further compare the NCI values of the set of nodes and may select the parent node among nodes 104 and 106 based on the comparison of NCI values of nodes 104 and 106. Alternatively, nodes 102, 104, 106, 108 and 110 may select the parent node from among themselves by exchanging their NCI values and information regarding the selected parent node may be communicated to node 106₂.

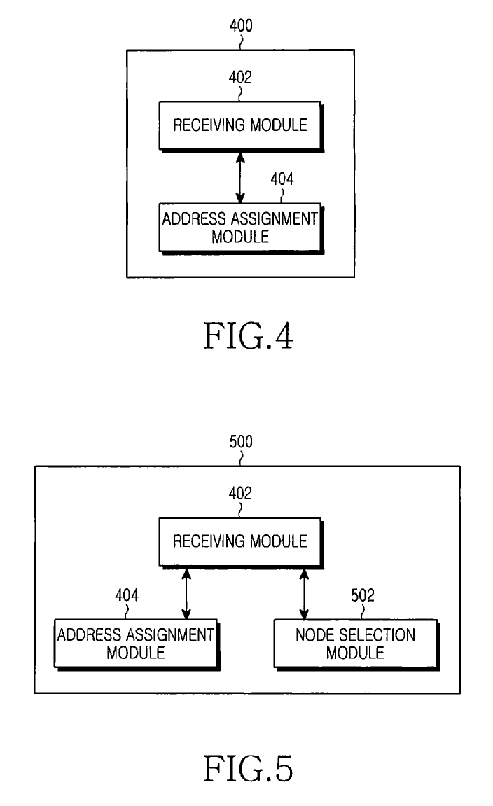

Once the parent node, for example, node 106 is selected, at step 306, the method 300 includes receiving the NCI value of node 106₂ at node 106. Further, at step 308, the set of addresses is determined based on the NCI value of node 106₂, as previously disclosed in conjunction with FIG. 2. Thereafter, the set of addresses is assigned to node 106₂, at step 310 of the method 300, as also disclosed in conjunction with FIG. 2. The present invention also provides a system for managing the addresses in the network 100, as disclosed in conjunction with FIG. 4.

Referring now to FIG. 4, a block diagram of a system 400 is shown for managing addresses in a network, such as the network 100, according to one embodiment of the present invention. The system 400 includes a receiving module 402 and an address assignment module 404.

Herein, for the purpose of this description, the system 400 for managing the addresses in the network 100 is described by taking examples of nodes 106, 106₁ and 106₂, and it should not be considered as limiting. The receiving module 402 and the address assignment module 404 are disposed in a first node, such as node 106. The receiving module 402 and the address assignment module 404 may be composed of hardware components, software programs, firmware, or combinations of these.

The receiving module 402 is configured to receive an NCI value of a second node, such as node 106₁. The address assignment module 404 is configured to assign a set of addresses to node 106₁ based on the NCI value of node 106₁. The address assignment module 404 performs the assignment of the set of addresses as explained in conjunction with FIG. 2.

It will be apparent to those skilled in the art that though the receiving module 402 and the address assignment module 404 are explained as disposed in node 106, but these components will be present in each node of the network 100. More specifically, each node of the network 100 may act as the first node and the second node, i.e., the parent node and the child node, respectively. Therefore, these components present in each node of the network 100 facilitate managing addresses in the network 100.

In another embodiment of the present invention, the present invention provides a system 500, as shown in FIG. 5. The system 500 includes a node selection module 502 in addition to the receiving module 402 and the address assignment module 404. The node selection module 502 may be present in every node that may act as the second node, i. e., the child node in the network 100. For example, the node selection module 502 may be present in node 106₂. In one embodiment of the present invention, the node selection module 502 is configured to select the first node for the second node, when the second node tends to join the network 100. For example, when the second node, such as node 106₂ being the incoming node, wants to join the network 100, the node selection module 502 selects the first node, i.e., the parent node for node 106₂.

In order to select the first node for node 106₂, the node selection module 502 may communicate with a set of nodes, for example, nodes 104 and 106 among nodes 104, 106, 108 and 110. The node selection module 502 is configured to receive the NCI values of nodes 104 and 106 and selects the parent node based on a comparison of their NCI values. For example, the node selection module 502 may select node 106 as the parent node, when the NCI value of node 106 is greater than the NCI value of node 104.

In another embodiment of the present invention, the node selection module 502 may also be present in each of nodes 104, 106, 108 and 110. The node selection module 502 present in these nodes may communicate among each other to select the parent node from among these nodes for any incoming node, such as node 106₂.

Various embodiments of the present invention provide methods and systems, such as the methods and the systems described herein for assigning addresses in a network. The methods and systems assign addresses to a node based on a capability of the node, which ensures a reliable network life time and help to avoid over burdening of the node in terms of serving child nodes of the node. Therefore, the methods and systems disclosed herein are efficient and effective in assigning the addresses to the nodes in the network, thereby saving significant energy in the network. Therefore, the methods and systems disclosed herein will be particularly helpful in energy constraints networks.

As described above, the embodiments of the present disclosure may be embodied in the form of computer-implemented processes and systems for managing addresses in a network. Embodiments of the present disclosure may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the disclosure. The present disclosure may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the disclosure. When implemented on a general-purpose microprocessor, the computer program code segments configure the microprocessor to create specific logic circuits.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A method for managing addresses in a network, the network including a plurality of nodes, the method comprising the steps of:
receiving at a first node, a node capability index value of a second node from the second node;
determining at the first node, a set of addresses to be assigned to the second node based on the node capability index value of the second node; and
assigning by the first node the set of addresses to the second node.

2. The method of claim 1, wherein the second node is an incoming node adapted to connect to the first node.

3. The method of claim 2, further comprising selecting the first node from the plurality of nodes based on node capability index values of the plurality of nodes prior to receiving the node capability index value from the second node.

4. The method of claim 3, wherein selecting the first node comprises:
receiving at the second node the node capability index values of a set of nodes of the plurality of nodes;
comparing at the second node the node capability index values of the set of nodes; and
choosing the first node from the set of nodes based on the comparison of the node capability index values of the set of nodes.

5. The method of claim 1, wherein determining the set of addresses comprises calculating a fraction of unassigned addresses available at the first node.

6. The method of claim 1, wherein the node capability index value of the second node is based on a plurality of node capability parameters.

7. The method of claim 6, wherein the plurality of node capability parameters is at least one of a power source, an energy level, a functional capability, a transceiver capability, a processing power and a storage capability.

8. The method of claim 1, wherein the second node is a child node of the first node.

9. The method of claim 8, further comprising exchanging a block of addresses between the first node and the second node based on a change in the node capability index value of the second node.

10. The method of claim 8, further comprising returning addresses available at the second node to the first node by the second node, when the second node leaves the network.

11. A system for managing addresses in a network comprising a plurality of nodes, the system comprising:
a receiving module disposed in a first node, the receiving module configured to receive a node capability index value of a second node; and
an address assignment module disposed in the first node and communicating with the receiving module, the address assignment module configured to assign a set of addresses to the second node based on the node capability index value of the second node.

12. The system of claim 11, wherein the second node is an incoming node adapted to connect to the first node.

13. The system of claim 11, wherein the second node is a child node of the first node.

14. The system of claim 11, wherein the address management module is further configured to calculate a fraction of unassigned addresses available at the first node for assigning the set of addresses to the second node, the fraction of unassigned addresses calculated based on the node capability index value of the second node.

15. The system of claim 11, further comprising a node selection module for selecting the first node for the second node from a set of nodes of the plurality of nodes when the second node is an incoming node, wherein the node selection module selects the first node based on a comparison of node capability index values of the set of nodes.

16. The system of claim 11, wherein the address management module is further configured to exchange a block of addresses between the first node and the second node based on a change in the node capability index value of the second node.

17. The system of claim 11, wherein the node capability index value of the second node is based on a plurality of node capability parameters.

18. The system of claim 11, wherein the plurality of node capability parameters is at least one of a power source, an energy level, a functional capability, a transceiver capability, a processing power and a storage capability
